(19) United States
(12) Patent Application Publication
(10) Pub. No.: US 2010/0263811 A1
(43) Pub. Date: Oct. 21, 2010

(54) POSITIONING ASSEMBLY FOR SECURING TOP BOXES OF WINDOW BLINDS

(76) Inventor: ZHENG-YAO GAO, Taichung City (TW)

Correspondence Address: PHILLIP LIU, 6980, WHITEOAK DR.,, RICHMOND, BC, V7E 4Z9, CA

(21) Appl. No.: 12/426,190

(22) Filed: Apr. 17, 2009

(51) Int. Cl. E06B 9/00

(52) U.S. Cl. 160/368.1

(57) ABSTRACT

A positioning assembly for securing top box of window blinds or shades includes a positioning member which includes multiple hooking members, guide posts and two guide members. An adjustment member includes multiple lugs extending from a top thereof and each lug has an insertion hole. An extension splits from the adjusting member so as to insert into the slot of the positioning member. An engaging portion extends from a bottom of the adjustment member. Multiple springs are mounted to the guide posts and biased between the lugs and the guide posts which are inserted into the insertion holes of the lugs. The top box having an open side which is defined between a first lip and a second lip, wherein the first lip is hooked to one of the hooking members and the second lip is engaged with the engaging portion of the adjustment member.

### FIELD OF THE INVENTION

The present invention relates to a positioning assembly for securing different sizes of top boxes of window blinds or shades.

### BACKGROUND OF THE INVENTION

A conventional window blinds or shades generally includes a top box fixed to the wall and blinds or a shade is connected to the top box to cover or partially cover the window. The top box is secured to multiple positioning members which are fixed on the wall and each positioning member is a transverse U-shaped plate which opens forward and toward the head box which is then snapped to the positioning members.

However, the conventional positioning members can only be connected with the head box of a fixed size so that different window blind or shade requires another set of positioning members. Furthermore, the positioning members are simply a thin metal plate which holds the head box, when removing the head box from the positioning members, the positioning members are easily deformed or even damaged.

The present invention intends to provide a positioning assembly for securing different sizes of top boxes of window blinds or shades, the positioning assembly includes a positioning member fixed on the wall and an adjustment member which is movably connected between the positioning member and the top box, so that different sizes of the top box can be connected to the positioning assembly.

### SUMMARY OF THE INVENTION

The present invention relates to a positioning assembly for securing top box of window blinds or shades, the positioning assembly comprises a positioning member to be fixed on the all and includes a top end and a bottom end. Multiple hooking members and guide posts extend from a connection face thereof and the guide posts extend downward. A slot is defined through the positioning member. An adjustment member includes multiple lugs extending from a top thereof and each lug has an insertion hole. An extension splits from the adjusting member and protrudes from a face thereof. An engaging portion extends from a bottom of the adjustment member and toward in opposite direction of a direction that the extension protrudes. Multiple springs are mounted to the guide posts respectively and biased between the lugs of the adjustment member and respective heads of the guide posts which are inserted into the insertion holes of the lugs. The extension of the adjustment member is inserted into the slot of the positioning member. The top box has an open side and includes a first lip and a second lip on two sides of the open side. The first lip is hooked to one of the hooking members and the second lip is engaged with the engaging portion of the adjustment member by pushing the adjustment member to compress the springs first and then releasing the springs to secure the top box to the positioning member.

The primary object of the present invention is to provide a positioning assembly for securing the top box of window blinds or shades to the wall, wherein the positioning assembly allows different sizes of the top boxes to be connected to the positioning members of the positioning assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the top box connected to the positioning assembly of the present invention;

FIG. 2 is a perspective view to show the top box and the positioning assembly of the present invention;

FIG. 3 shows a plane view to show that the adjustment member is connected to the positioning member of the positioning assembly of the present invention;

FIG. 4 shows that the adjustment member is pushed upward to compress the springs on the guide posts of the positioning member of the positioning assembly of the present invention;

FIG. 5 is a side cross sectional view to that the adjustment member is connected to the positioning member which is to be fixed on the wall;

FIG. 6 is a side cross sectional view to that the adjustment member is connected to the positioning member which is fixed on the wall by bolts;

FIG. 7 is a side cross sectional view to that the second lip of the top box is engaged with the engaging portion of the adjustment member;

FIG. 8 is a side cross sectional view to that the top box pivoted toward the adjustment member;

FIG. 10 is a side cross sectional view to that the first lip of the top box is moved toward the adjustment member and engaged with the hooking member, and

FIG. 11 is a side cross sectional view to that the top box is released and the springs push the adjustment member downward, the first lip and second lip of the top box are engaged with the hooking member and the engaging portion respectively.

### DETAILED DESCRIPTION OF THE PREFERRED EMBODIMENT

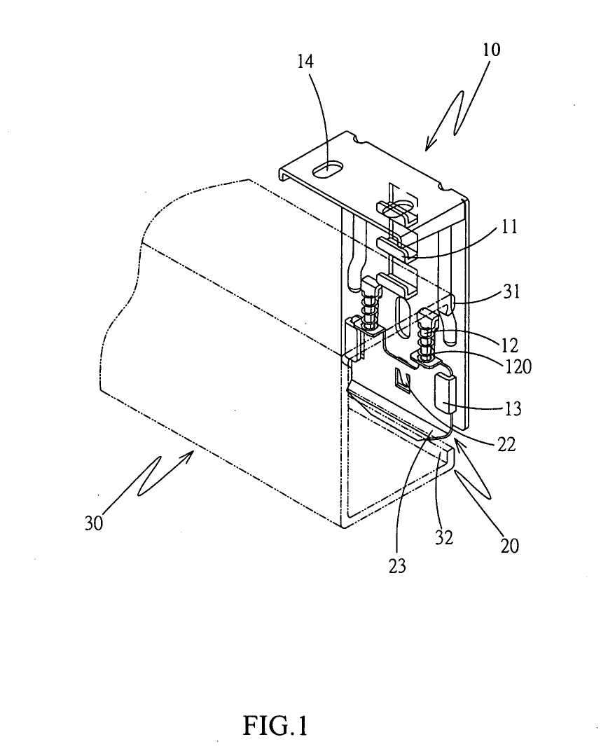

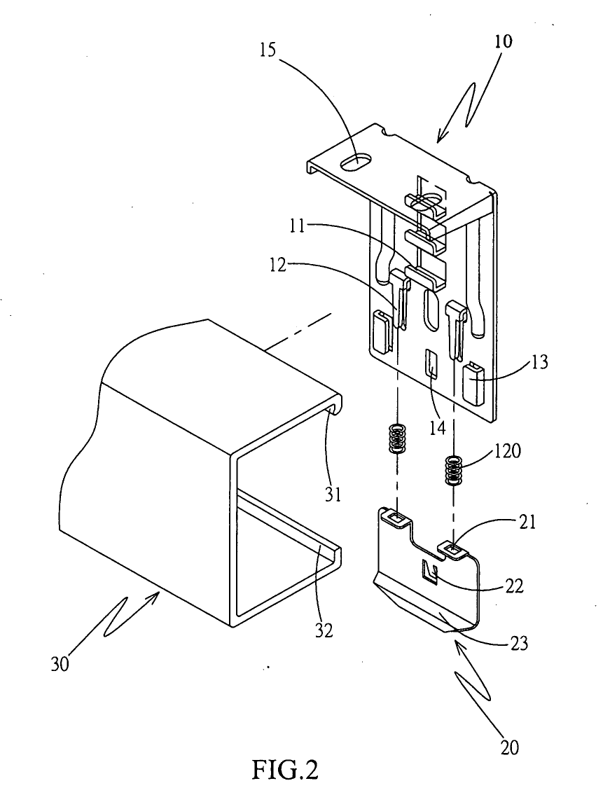

Referring to FIGS. 1 and 2, the positioning assembly for securing different sizes of top boxes of window blinds or shades of the present invention comprises a plurality of positioning members 10 fixed on a wall (not shown) and each positioning member 10 includes a top end and a bottom end. Multiple hooking members 11 and multiple guide posts 12 extend from a connection face of the positioning member 10. In this embodiment, there are three hooking members 11 and two guide posts 12. Each guide post 12 is located at a gap from the connection surface and extends downward. A slot 14 is defined through the positioning member 10 and two guide members 13 extend from the connection face of the positioning member 10. Each guide member 13 has a guide groove which opens laterally and the slot 14 is located between the two guide members 13. Each positioning member 10 includes a top plate extending from the top end thereof and multiple fixing holes 15 are defined through the top plate. Bolts extend through the fixing holes 15 and another fixing hole through the positioning member 10 so as to fix the positioning member 10 on the wall as shown in FIG. 5.

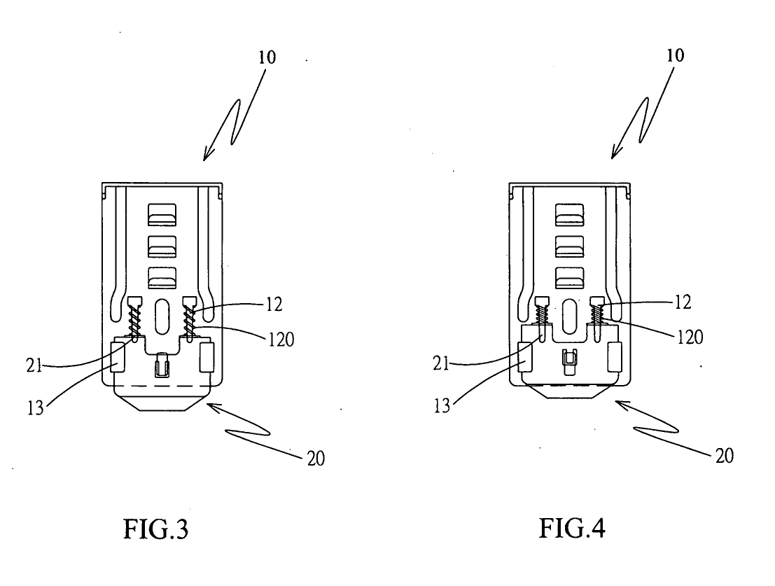

An adjustment member 20 includes two lugs extending from a top thereof and each lug has an insertion hole 21. An extension 22 splits from the adjusting member 20 and protrudes from a face thereof. An engaging portion 23 extends from a bottom of the adjustment member 20 and toward in opposite direction of a direction that the extension 22 protrudes. As shown in FIG. 3, two springs 120 are mounted to the guide posts 12 and biased between the lugs of the adjustment member 20 and respective heads of the guide posts 12 which are inserted into the insertion holes 21 of the lugs. The extension 22 of the adjustment member 20 is inserted into the slot 14 of the positioning member 10 and two sides of the adjustment member 20 are slidably engaged with the grooves of the guide members 13.

The top box 30 includes an open side and including a first lip 31 and a second lip 32 on two sides of the open side. The first lip 31 is hooked to one of the hooking members 11 and the second lip 32 is engaged with the engaging portion 32 of the adjustment member 20.

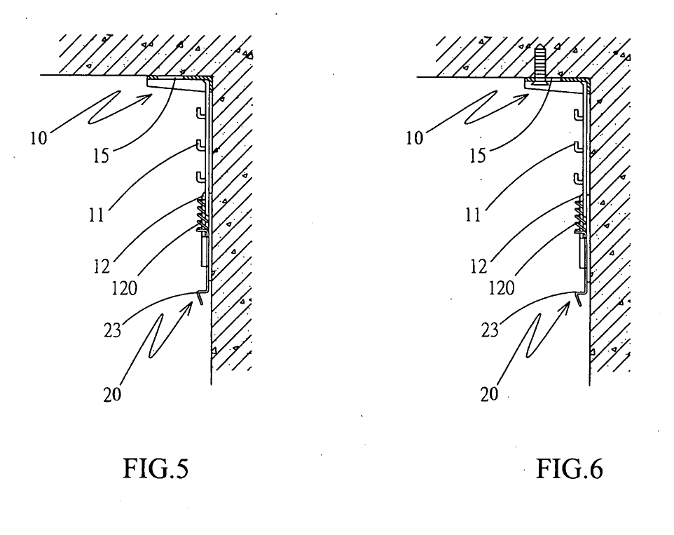

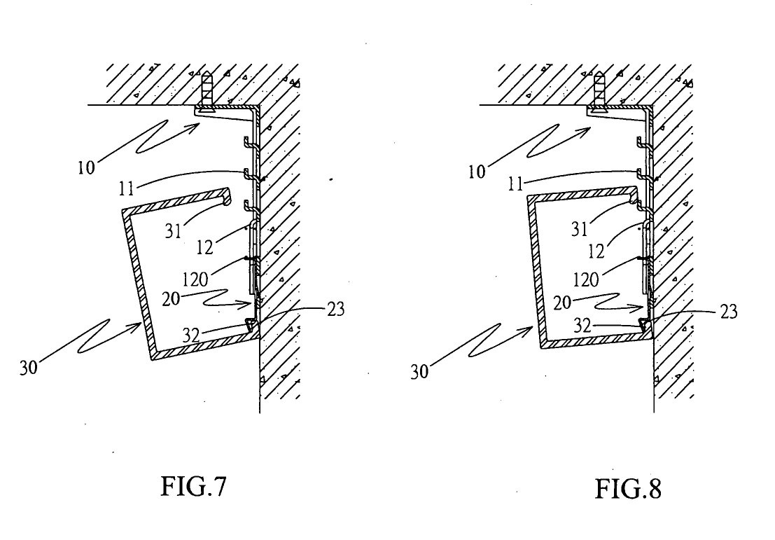

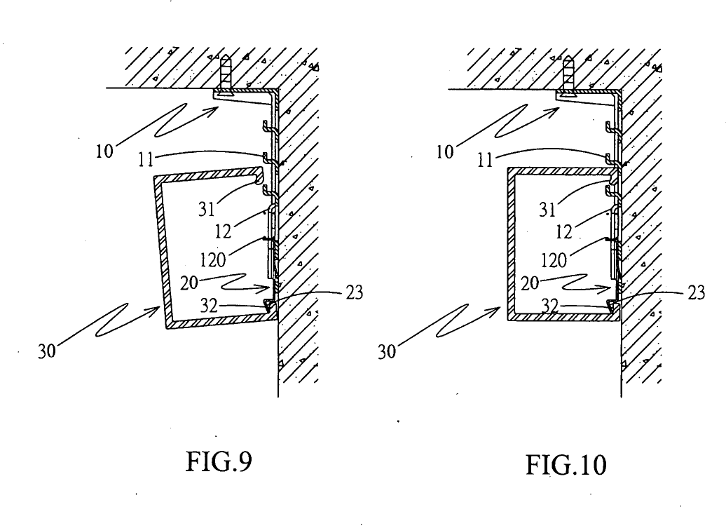

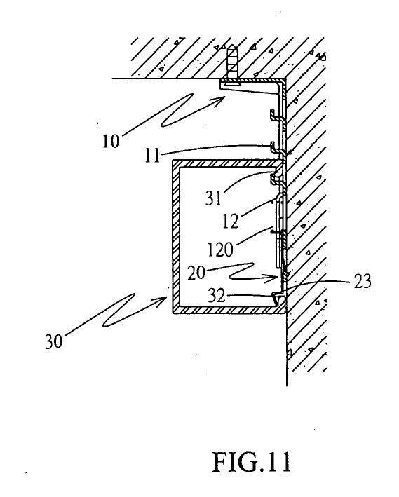

As shown in FIGS. 5 to 11, the positioning member 10 is positioned to the desired position of a wall and the adjustment member 20 is connected to the positioning member 10 by engaging the extension 22 of the adjustment member 20 with the slot 14 of the positioning member 10, inserting the guide posts 12 of the positioning member 10 into the insertion holes 21 of the adjustment member 20 with the springs 120 mounted to the guide posts 12, and sliding the adjustment member 20 between the two guide members 13. Bolts are used to extend through the fixing holes 15 of the positioning member 10 to fix the positioning member 10 on the wall. The second lip 32 of the top box 30 is first engaged with the engaging portions 23 of the adjustment members 20 and the user pushes the top box 30 upward to move the adjustment members 20 to compress the springs 120 until the first lip 31 of the top box 30 reaches the desired hooking members 11 of the positioning members 10. The first lip 31 includes a rounded end which is easily moved over the hooking members 11 to engage the first lip 31 with the hooking members 11. After the first lip 31 is hooked with the desired hooking members 11 and the top box 30 is then released, the springs 120 move the adjustment members 20 downward, so that the top box 30 is secured between the engaging portions 23 of the adjustment members 20 and the hooking members 11 of the positioning members 10.

By the adjustment members 20, different sizes of the top box 30 can be connected to the desired hooking members 11 of the positioning members 10 without replacing positioning members 10. The guide posts 12 are restricted to be moved through the insertion holes 21 of the lugs of the adjustment members 20 and the two sides of the adjustment member 20 are slidably engaged with the grooves of the guide members 13, so that movement of the adjustment members 20 are ensured to be moved smoothly without shaking.

While we have shown and described the embodiment in accordance with the present invention, it should be clear to those skilled in the art that further embodiments may be made without departing from the scope of the present invention.

What is claimed is:

1. A positioning assembly for securing top box of window blinds or shades, comprising:
a positioning member including a top end and a bottom end, multiple hooking members and multiple guide posts extending from a connection face of the positioning member, the guide posts extending downward, a slot defined through the positioning member;
an adjustment member having multiple lugs extending from a top thereof and each lug having an insertion hole, an extension splitting from the adjusting member and protruding from a face thereof, an engaging portion extending from a bottom of the adjustment member and toward in opposite direction of a direction that the extension protrudes, multiple springs mounted to the guide posts and biased between the lugs of the adjustment member and respective heads of the guide posts which are inserted into the insertion holes of the lugs, the extension of the adjustment member inserted into the slot of the positioning member, and
a top box having an open side and including a first lip and a second lip on two sides of the open side, the first lip hooked to one of the hooking members and the second lip engaged with the engaging portion of the adjustment member.

2. The positioning assembly as claimed in claim 1, wherein the positioning member includes a top plate extending from the top end thereof and multiple fixing holes are defined through the top plate.

3. The positioning assembly as claimed in claim 1, wherein two guide members extend from the connection face of the positioning member and each guide member has a guide groove which opens laterally, two sides of the adjustment member are slidably engaged with the grooves of the guide members.
